(19) United States
(12) Patent Application Publication
(10) Pub. No.: US 2026/0088501 A1
(43) Pub. Date: Mar. 26, 2026

(54) MULTIBEAM SECTOR-SPLITTING BASE STATION ANTENNAS HAVING COMPACT BEAMFORMING NETWORKS

(71) Applicant: Outdoor Wireless Networks LLC, Richardson, TX (US)

(72) Inventors: Kumara Swamy Kasani, Telangana (IN); Ligang Wu, Suzhou (CN); S Bala Subramanian, Tirunelveli (IN); Kamalakar Yeddula, Kurnool (IN); Sai Krishna Maddula, Guo (IN)

(21) Appl. No.: 19/310,094

(22) Filed: Aug. 26, 2025

(30) Foreign Application Priority Data
Sep. 20, 2024 (CN) 2024113160430

(51) Int. Cl. H01Q 3/36; H01Q 1/24; H01Q 19/10; H01Q 21/29

(52) U.S. Cl. CPC H01Q 3/36; H01Q 1/246; H01Q 19/10; H01Q 21/29

(57) ABSTRACT

Multibeam base station antennas include an antenna array that includes a plurality of columns of radiating elements and a beamforming network having at least two rows and two columns of directional couplers, where adjacent pairs of directional couplers in each row are connected to each other by respective ones of a plurality of delay lines, where at least some of the delay lines have a wave shape having multiple peaks and valleys.

### CROSS-REFERENCE TO RELATED APPLICATION

The present application claims priority under 35 U.S.C. § 119 to Chinese Patent Application No. 202411316043.0, filed Sep. 20, 2024, the entire content of which is incorporated herein by reference as if set forth in its entirety.

### FIELD OF THE INVENTION

The present invention generally relates to radio communications and, more particularly, to multibeam sector-splitting base station antennas utilized in cellular and other communications systems.

### BACKGROUND

Cellular communications systems are well known in the art. In a typical cellular communications system, a geographic area is divided into a series of regions that are referred to as “cells,” and each cell is served by a base station. The base station may include baseband equipment, radios and base station antennas that are configured to provide two-way radio frequency (“RF”) communications with subscribers that are positioned throughout the cell. In many cases, the cell may be divided into a plurality of “sectors” in the azimuth plane (a horizontal plane that bisects the antenna that is parallel to the plane defined by the horizon), and separate base station antennas provide coverage to each of the sectors. The base station antennas are often mounted on a tower or other raised structure, with the radiation patterns (“antenna beams”) that are generated by the antennas directed outwardly to provide service to the respective sectors.

A common base station configuration is a “three sector” configuration in which a cell is divided into three 120° sectors in the azimuth plane, and the base station includes three base station antennas that provide coverage to the three respective sectors. Typically, each base station antenna will include one or more vertically-extending columns of radiating elements, each of which is configured to generate a separate antenna beam (or two antenna beams, if dual-polarized radiating elements are used, as is well understood in the art). Each column of radiating elements is connected to a feed network that subdivides an RF signal and feeds each sub-component of the RF signal to a respective subset of one or more of the radiating elements in the column. Typically, each radiating element is configured to generate a radiation pattern that has a Half Power Beam Width (“HPBW”) in the azimuth plane of about 65°, which ensures that the antenna beam provides good coverage throughout a 120° sector. The sub-components of the RF signal are phased so that the radiation patterns generated by each subset of one or more radiating elements constructively combine to produce a composite antenna beam having a narrowed HPBW (e.g., 15°-30°) in the elevation (vertical) plane.

As capacity requirements have grown, cellular network operators are now dividing some cells into more than three sectors. For example, cells may now be divided into six, nine, twelve, fifteen or eighteen sectors in the azimuth plane. Typically, multibeam “sector-splitting” antennas are used when cells are divided into more than three sectors. A multibeam sector-splitting antenna refers to a base station antenna that generates multiple antenna beams (per polarization) that have narrowed beamwidths in the azimuth plane (i.e., azimuth HPBWs of less than about 65°, and typically less than about 35°) , where the pointing directions of the multiple antenna beams are designed to split a sector into a plurality of sub-sectors. This allows a single base station antenna to generate the multiple antenna beams (per polarization) that provide coverage to the respective sub-sectors of a 120° sector.

For example, a six-sector base station will divide each 120° sector in the azimuth plane into two 60° sub-sectors. Such a six-sector base station will typically be served by three base station antennas that are each implemented as a “twin-beam” antenna that is designed to generate first and second antenna beams (per polarization) that provide coverage to the respective first and second 60° sub-sectors of each 120° sector. Each antenna beam may have a HPBW in the azimuth plane of about 30-35°. The first antenna beam may point at an angle of about −27° to −30° in the azimuth plane from the “boresight” pointing direction of the antenna and the second antenna beam may point at an angle of about 27° to 30° in the azimuth plane from the “boresight” pointing direction of the antenna. The boresight pointing direction of the antenna is the center, in the azimuth plane, of the 120° sector served by the antenna. In this fashion, the 120° sector is split into two 60° sub-sectors that are covered by the respective first and second antenna beams.

Providing cellular service in large venues such as stadiums, arenas, convention centers, concert halls and the like may be particularly challenging, as very larger numbers of users may be located in a very small area. In such venues, multibeam sector-splitting base station antennas that generate three or more antenna beams per polarization may be used, where each antenna beam provides coverage to a respective 20°-40° (or smaller) sub-sector in the azimuth plane. When a 120° sector is sub-divided into sub-sectors, the system capacity can be increased significantly because the RF energy of each antenna beam is focused into a smaller area and therefore provides a higher antenna gain.

In order to generate antenna beams that have narrowed beamwidths in the azimuth plane, multibeam sector-splitting base station antennas typically include at least one multi-column antenna array, since transmitting an RF signal through multiple columns of radiating elements acts to expand the aperture of the antenna in the azimuth plane, which shrinks the azimuth beamwidths of the generated antenna beams. For example, a twin-beam antenna will typically use a three or four column array of radiating elements. While separate multi-column arrays of radiating elements may be used to generate each antenna beam, such an approach is typically commercially unacceptable because such an approach results in a very large and expensive antenna. Thus, multibeam antennas typically include beamforming networks, which allow multiple RF signals to be transmitted through a single multi-column array of radiating elements to generate multiple corresponding antenna beams that point in different directions.

Multibeam sector-splitting antennas are known in the art that include multiple RF ports (per polarization) that are coupled to a multi-column array of radiating elements through a Butler Matrix beamforming network. The beamforming network generates multiple antenna beams (per polarization) based on the RF signals input at the multiple RF ports, and the antenna beams are electrically steered so that each antenna beam provides coverage to a different sub-sector of, for example, a 120°sector. In addition, multibeam sector-splitting antennas are known in the art that use Blass Matrix or Nolen Matrix beamforming networks.

### SUMMARY

Pursuant to embodiments of the present invention, a multibeam sector-splitting base station antenna is provided that comprises an antenna array that includes a plurality of columns of radiating elements and a beamforming network having at least two rows and two columns of directional couplers, where adjacent pairs of directional couplers in each row are connected to each other by respective ones of a plurality of delay lines, where at least some of the delay lines have a wave shape having multiple peaks and valleys.

In some embodiments, the antenna array may include N columns of radiating elements and a plurality of RF ports are coupled to the antenna array through the beamforming network. The beamforming network may have M rows and N columns of directional couplers. In some embodiments, each row of the beamforming network may have a different number of directional couplers (e.g., Blass Matrix embodiments). In other embodiments, each row of the beamforming network may have a same number of directional couplers (e.g., Nolen Matrix embodiments).

In some embodiments, the multibeam antenna may also include a reflector, and radiators of the radiating elements of the antenna array may be mounted forwardly of the reflector, and the beamforming network may also be mounted forwardly of the reflector 102. In some embodiments, the beamforming network may be implemented in a printed circuit board, and the printed circuit board may be mounted on a front surface of the reflector. In some embodiments, at least some of the radiating elements that are fed by the beamforming network may be mounted on the printed circuit board.

In some embodiments, a first axis intersects all of the directional couplers in a first of the rows as well as at least one of the directional couplers that is part of a second of the rows. Moreover, a first distance between a first and a last of the directional couplers in a first of the rows may be less than a second distance between a first and a next to last of the directional couplers in a second of the rows.

In some embodiments, the beamforming network may be implemented in a beamforming network printed circuit board that is mounted behind a reflector of the base station antenna, and the beamforming network printed circuit board may include tabs that extend through openings in the reflector to electrically connect to a subset of the radiating elements. In such embodiments, multibeam antenna may further comprise a plurality of feedboard printed circuit boards that are mounted forwardly of the reflector, and each tab in the beamforming network printed circuit board extends through a slot in a respective one of the feedboard printed circuit boards. The beamforming network printed circuit board may be mounted substantially perpendicularly to a main surface of the reflector in some embodiments.

Pursuant to further embodiments of the present invention, multibeam sector-splitting base station antennas are provided that comprise an antenna array that includes a plurality of columns of radiating elements and a printed circuit board that includes a plurality of feedboard regions, a first beamforming region that includes a first beamforming network that comprises a plurality of directional couplers and a plurality of outputs, and a plurality of transmission lines that connect at least some of the outputs of the beamforming network to respective ones of the feedboard regions, where each feedboard region has one or more of the radiating elements of the antenna array mounted thereon.

In some embodiments, the multipurpose printed circuit board may further include a second beamforming region that comprises a second beamforming network, and at least some of the feedboard regions are interposed between the first beamforming region 560-1 and the second beamforming region. In some embodiments, the transmission lines may be microstrip transmission lines.

In some embodiments, the beamforming network(s) may comprise a Blass Matrix or a Nolen Matrix. In some embodiments, the at least one of the outputs of the beamforming network is connected to a feedboard printed circuit board by a coaxial cable. In such embodiments, the at least one of the radiating elements that is part of an outer one of the columns of radiating elements is mounted on the feedboard printed circuit board.

In some embodiments, the beamforming network has at least two rows and two columns of directional couplers, where adjacent pairs of directional couplers in each row are connected to each other by respective ones of a plurality of delay lines, where at least some of the delay lines have a wave shape with multiple peaks and valleys.

In some embodiments, a first axis intersects all of the directional couplers in a first of the rows as well as at least one of the directional couplers that is part of a second of the rows. In some embodiments, a first distance between a first and a last of the directional couplers in a first of the rows is less than a second distance between a first and a next to last of the directional couplers in a second of the rows.

In some embodiments, the multibeam antenna may further comprise a reflector, and radiators of the radiating elements and the beamforming network may be mounted forwardly of the reflector.

Pursuant to additional embodiments of the present invention, multibeam sector-splitting base station antennas are provided that comprise a reflector, an antenna array that includes a plurality of columns of radiating elements, where the radiating elements extend forwardly from the reflector, and a beamforming network printed circuit board that is mounted behind the reflector, the beamforming network printed circuit board including tabs that extend through openings in the reflector to electrically connect to a subset of the radiating elements.

In some embodiments, the multibeam antenna further comprises a plurality of feedboard printed circuit boards that are mounted forwardly of the reflector, and each tab in the beamforming network printed circuit board may extend through a slot in a respective one of the feedboard printed circuit boards.

In some embodiments, the beamforming network printed circuit board may be mounted substantially perpendicularly to a main surface of the reflector.

In some embodiments, a first axis intersects all of the directional couplers in a first of the rows as well as at least one of the directional couplers that is part of a second of the rows. In some embodiments, a first distance between a first and a last of the directional couplers in a first of the rows is less than a second distance between a first and a next to last of the directional couplers in a second of the rows.

In some embodiments, the beamforming network further comprises a plurality of delay lines, and adjacent pairs of the directional couplers in each row are connected to each other by respective ones of the delay lines. In some embodiments, at least one of the delay lines has a wave shape with multiple peaks or multiple valleys.

In some embodiments, the beamforming network printed circuit board includes a matrix of directional couplers. In some embodiments, the matrix of directional couplers comprises a Blass Matrix or a Nolen Matrix.

Pursuant to yet additional embodiments of the present invention, multibeam antennas are provided that comprise an antenna array and a beamforming network having a plurality of directional couplers that are interconnected by a plurality of transmission lines to define a plurality of rows and columns of directional couplers. The directional couplers in the beamforming networks are arranged so that a first axis intersects all of the directional couplers in a first of the rows as well as at least one of the directional couplers that is part of a second of the rows.

In some embodiments, the beamforming network includes at least three rows of directional couplers and at least four columns of directional couplers. In some embodiments, a second axis that is perpendicular to the first axis intersects the first directional coupler in each of the rows of directional couplers. In some embodiments, a first distance between a first and a last of the directional couplers in a first of the rows is less than a second distance between a first and a next to last of the directional couplers in a second of the rows.

Pursuant to still other embodiments of the present invention, multibeam antennas are provided that comprise an antenna array and a beamforming network having a plurality of directional couplers that are interconnected by a plurality of transmission lines to define a plurality of rows and columns of directional couplers. A first distance between a first and a last of the directional couplers in a first of the rows is less than a second distance between a first and a next to last of the directional couplers in a second of the rows. In some embodiments, the transmission lines in a first of the rows are straight transmission lines and the transmission lines in a last of the rows are meandered transmission lines.

### BRIEF DESCRIPTION OF THE DRAWINGS

FIG. 1A is a schematic block diagram of a multibeam sector-splitting base station antenna according to embodiments of the present invention.

FIG. 1B is a schematic block diagram that illustrates the feed networks of the multibeam sector-splitting antenna of FIG. 1A in greater detail.

FIG. 1C is a schematic block diagram illustrating an example Blass Matrix implementation of one of the beamforming networks of FIG. 1B.

FIG. 2A is a side view of a printed circuit board implementation of a conventional Blass Matrix beamforming network.

FIG. 2B is a collage that includes a plan (top) view of each metallization layer of the printed circuit board of FIG. 2A.

FIG. 2C is a rear view of a conventional multibeam sector-splitting base station that includes a plurality of the Blass Matrix printed circuit boards of FIGS. 2A-2B with the radome of the antenna removed.

FIG. 2D is a schematic perspective view of two of the Blass Matrix printed circuit boards of FIGS. 2A-2B mounted on respective heat dissipation plates.

FIG. 3A is a side view of a printed circuit board implementation of a Blass Matrix beamforming network according to embodiments of the present invention.

FIG. 3B is a collage that includes a plan (top) view of each metallization layer of the printed circuit board of FIG. 3A.

FIG. 3C is an enlarged view of a small portion FIG. 3B.

FIG. 3D is a plan view of an alternative printed circuit board implementation of the Blass Matrix beamforming network of FIGS. 3A-3B that has a different layout of the directional couplers.

FIG. 3E is a rear view of a multibeam sector-splitting base station antenna according to embodiments of the present invention that includes twenty of the Blass Matrix printed circuit boards of FIGS. 3A-3B.

FIG. 4A is a plan view of a multipurpose printed circuit board that includes two Blass Matrix beamforming networks and eight feedboards implemented therein.

FIG. 4B is a schematic view of a multibeam sector-splitting base station antenna according to further embodiments of the present invention that is implemented using ten of the multipurpose printed circuit boards of FIG. 4A.

FIG. 5A is a schematic partial view of a multibeam sector-splitting base station antenna according to further embodiments of the present invention.

FIG. 5B is a perspective rear view of a portion of the antenna of FIG. 5A.

FIG. 6 is a plan view of several of the printed circuit boards of a multibeam sector-splitting base station antenna according to further embodiments of the present invention.

### DETAILED DESCRIPTION

As discussed above, multibeam sector-splitting base station antennas are known in the art that use Blass Matrix or Nolen Matrix beamforming networks. These multibeam sector-splitting base station antennas may have performance advantages over multibeam sector-splitting base station antennas that employ Butler Matrix beamforming networks, as Butler Matrix beamforming networks may generate antenna beams having azimuth beamwidths that are larger than desired, which both reduces the antenna gain and increases interference between sub-sectors and with neighboring sectors. In addition, multibeam sector-splitting base station antennas that employ Butler Matrix beamforming networks also experience so-called “beam peak walking,” which refers to a phenomena where the azimuth pointing angle of each antenna beam shifts depending upon the frequency of the input RF signals. Such beam peak walking not only effects the pointing directions of the antenna beams, but also changes the beamwidth and beam shape. These effects are undesirable because it means that the regions covered by the respective antenna beams may vary significantly as a function of frequency.

Multibeam sector-splitting base station antennas that use Blass Matrix or Nolen Matrix beamforming networks typically exhibit little or no beam peak walking, and may also generate antenna beams having more appropriate azimuth beamwidths. Unfortunately, however, Blass Matrix and Nolen Matrix beamforming networks each include a large number of directional couplers, and since ten to twenty-five such beamforming networks are typically employed in an antenna, they can take up a significant amount of space and can be expensive to fabricate. In addition, these beamforming networks include resistive terminations that absorb some of the RF energy, and at the transmit power levels used by base station antennas this can result in very high temperatures that can potentially damage components of the base station antenna.

Pursuant to embodiments of the present invention, multibeam base station antennas are provided that have improved beamforming networks that may be smaller and less expensive than conventional beamforming networks. Base station antennas that include these beamforming networks may also eliminate the need for a large number of coaxial cables, which may reduce the weight of the antenna, and can eliminate the need for dozens or even hundreds of solder joints. As forming solder joints is a labor intensive operation and because poorly-formed solder joints are potential source of passive intermodulation (“PIM”) distortion, the base station antennas according to embodiments of the present invention may also be lighter and easier to manufacture than conventional antennas and may be less prone to PIM distortion. Moreover, in some of the embodiments, disclosed herein, the beamforming networks may more efficiently dissipate heat generated in the resistive terminations. The multibeam base station antennas according to embodiments of the present invention may be implemented using, for example, either Blass Matrix or Nolen Matrix beamforming networks.

The beamforming networks according to embodiments of the present invention may be implemented using printed circuit boards, and hence may be referred to herein as, for example, Blass Matrix printed circuit boards and Nolen Matrix printed circuit boards. As is known in the art, a Blass Matrix is a beamforming network that includes a plurality of rows and columns of directional couplers that are connected by transmission lines, and a Nolen Matrix is a beamforming network that likewise includes a plurality of rows and columns of directional couplers that are connected by transmission lines, but the number of directional couplers provided may differ in different rows. Delay elements, which typically are formed by meandering the transmission lines so that the transmission lines act as both a transmission line and as a delay element, are included along selected ones of the transmission lines in both a Blass Matrix and in a Nolen Matrix.

Pursuant to embodiments of the present invention, Blass Matrix and Nolen Matrix based beamforming networks are provided in which the spacings between adjacent rows of directional couplers are significantly reduced as compared to conventional Blass Matrix and Nolen Matrix based beamforming networks. These reduced spacings may be achieved by implementing some of the delay elements as transmission line segments that have a wave shape with multiple peaks and valleys. The use of such delay elements may increase the size of the Blass Matrix or Nolen Matrix printed circuit board in the length dimension, but may also allow a more significant decrease in the size of the printed circuit board in the width dimension. This approach may, for example, reduce the area of the Blass Matrix or Nolen Matrix printed circuit board by 50% or more.

In other embodiments of the present invention, multibeam sector-splitting base station antennas are provided that include multipurpose printed circuit boards that include a pair of beamforming networks as well as feedboard circuits for a plurality of radiating elements. By implementing both the beamforming networks and the feedboard circuits on a common printed circuit board, the need for cabled connections between beamforming network printed circuit boards and feedboard printed circuit boards may be reduced or eliminated, as printed circuit board based RF transmission lines may be used instead to make these connections. As a single cabled connection between a beamforming network printed circuit board and a feedboard printed circuit board may require as many as four solder joints (namely a first pair of solder joints that connect the center conductor of the coaxial cable to the respective printed circuit boards and a second pair of solder joints that connect the ground conductor of the coaxial cable to the respective printed circuit boards), hundreds of solder joints are required to connect the beamforming network printed circuit boards to the feedboard printed circuit boards in a typical conventional multibeam sector-splitting base station antenna. The base station antennas according to embodiments of the present invention may eliminate the need for some or all of these solder joints. Moreover, the multipurpose printed circuit boards are mounted on the front side of the reflector, which may save room behind the reflector and which may dissipate heat generated in the beamforming networks more effectively.

Pursuant to still further embodiments of the present invention, multibeam sector-splitting base station antennas are provided that have beamforming network printed circuit boards that are mounted behind a reflector of the antenna. These beamforming network printed circuit boards include tabs that extend through openings in the reflector to physically and electrically connect to respective feedboard printed circuit boards. The feed board printed circuit boards may be mounted on the front side of the reflector and the beamforming network printed circuit boards may extend perpendicular to the reflector and the feed board printed circuit boards. By having the beamforming network printed circuit boards physically and electrically connect directly to the feedboard printed circuit boards, the need for coaxial cable connections may be eliminated.

Embodiments of the present invention will now be discussed in greater detail with reference to the attached drawings.

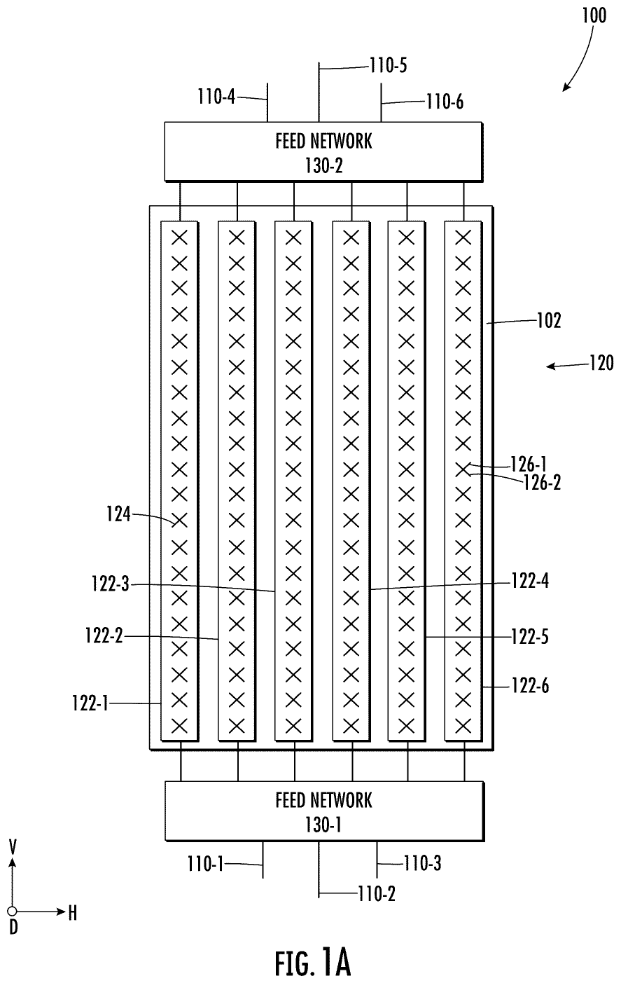

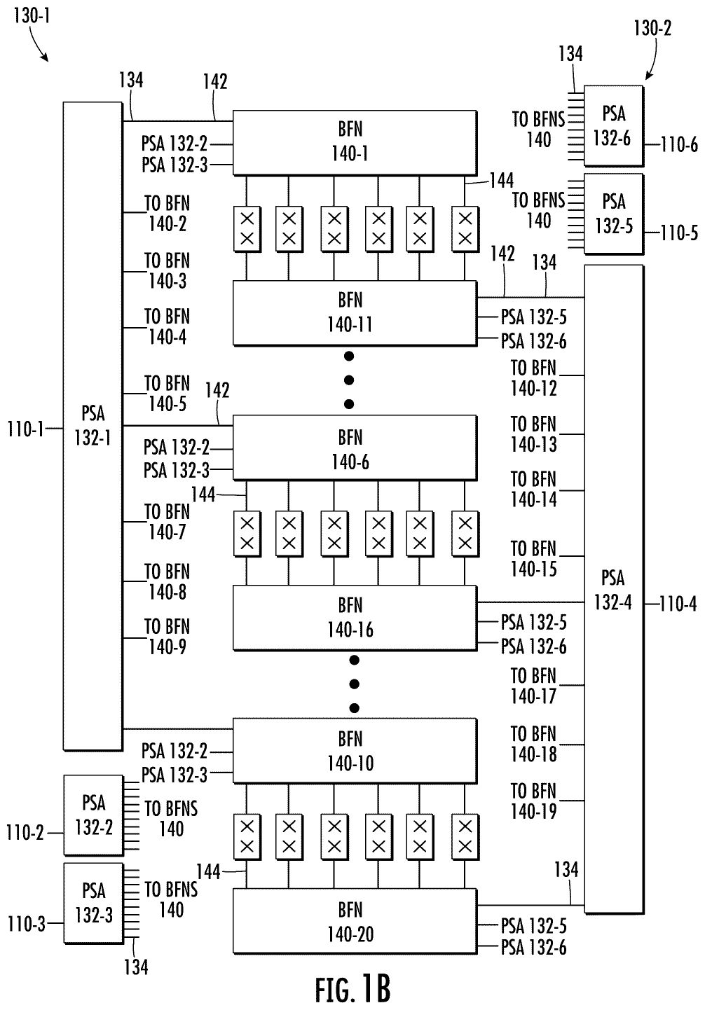

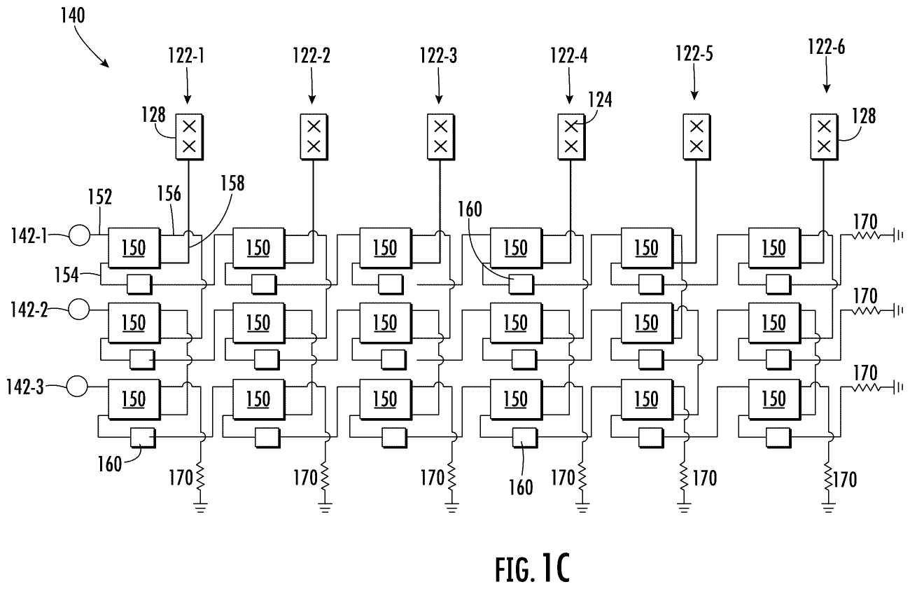

FIG. 1A is a schematic block diagram of a multibeam sector-splitting base station antenna 100 according to embodiments of the present invention. As shown in FIG. 1A, the multibeam sector-splitting base station antenna 100 includes six RF connector ports 110-1 through 110-6 (also referred to herein as “RF ports”) that are used to input RF signals to the base station antenna 100 from one or more radios, such as remote radio heads. Herein, when multiple of the same elements are included in an antenna, the elements may be referred to individually by their full reference numeral (e.g., RF connector port 110-2) and collectively by the first part of their reference numerals (e.g., the RF connector ports 110). The RF connector ports 110-1 through 110-16 may comprise, for example, RF connectors, and may be connected to RF ports on one or more radios via, for example, coaxial cables. The radios are typically external to the antenna 100 and are not shown in FIG. 1A.

The antenna 100 further includes an antenna array 120 that has a plurality of columns 122 of dual-polarized radiating elements 124 that are mounted to extend forwardly from a reflector 102. The reflector 102 may comprise a flat metal surface that acts as a ground plane for the radiating elements 124 and that redirects forwardly RF radiation that is emitted rearwardly by the radiating elements 124. In the depicted embodiment, the antenna includes a total of six columns 122-1 through 122-6 of radiating elements 124 and the antenna 100 is configured to feed the antenna array 120 so that it will generate three antenna beams (at each polarization) that provide service to three respective 40° sub-sectors in the azimuth plane. Each column 122 of radiating elements 124 may extend in a vertical direction, and the columns 122 may be spaced apart from each other in a horizontal direction to form a planar array 120 of radiating elements 124. It will be appreciated, however, that in other embodiments different numbers of columns 122 may be provided and/or the antenna 100 may be configured to generate different numbers of antenna beams.

In the depicted embodiment, each column 122 includes twenty radiating elements 124. It will be appreciated, however, that in other embodiments different numbers of radiating elements 124 may be included in each column 122. Each dual-polarized radiating element 124 includes a first polarization radiator 126-1 and a second polarization radiator 126-2. A pair of feed networks (one for each polarization) 130-1, 130-2 are provided that connect the RF ports 110 to the antenna array 120. Each feed network 130-1, 130-2 includes a plurality of beamforming networks (“BFN”) 140. The sector-splitting antenna 100 may split a 120° in the azimuth plane sector into three 40° sub-sectors in the azimuth plane, providing a separate antenna beam (per polarization) for each sub-sector.

Each beamforming network 140 may be implemented as a 3×6 Blass Matrix in example embodiments. The three first polarization RF connector ports 110-1 through 110-3 are connected to the three inputs of the first Blass Matrix 140-1, and the three second polarization RF connector ports 110-4 through 110-6 are connected to the three inputs of the second Blass Matrix 140-2. The six outputs of the first Blass Matrix 140-1 are connected to the respective columns 122 of the six-column antenna array 120, and the six outputs of the second Blass Matrix 140-2 are connected to the respective columns 122 of the six-column antenna array 120.

FIG. 1B is a schematic block diagram that illustrates in greater detail how the feed networks 130-1, 130-2 connect the RF ports 110-1 through 110-6 to the antenna array 120. Only six rows of the twenty rows of radiating elements 124 of antenna array 120 and only six of the twenty beamforming networks 140 are shown in FIG. 1B to simplify the drawing.

As shown in FIG. 1B, the first feed network 130-1 includes three phase shifter assemblies 132-1 through 132-3 that are connected to the first through third RF ports 110-1 through 110-3, respectively. The second and third phase shifter assemblies 132-2, 132-3 (as well as the fifth and sixth phase shifter assemblies 132-5, 132-6, which are discussed below) are shown in FIG. 1B using small blocks to fit the feed network 130-1 on a single drawing sheet. Each phase shifter assembly 132 includes ten outputs. Each phase shifter assembly 132 is configured to receive RF signals from a respective one of the RF ports 110 and to subdivide those RF signals into ten sub-components. Each phase shifter assembly 132 is further configured to impart a variable phase taper to the ten sub-components that will impart a desired amount of electronic downtilt to the generated antenna beams. Phase shifters, such as electromechanical phase shifters, that can impart such an electronic downtilt are well known in the art and hence further description of the phase shifter assemblies 132 will not be discussed herein. The phase shifter assemblies 132 can be controlled via control signals so that the amount of electronic downtilt can be changed from a remote location. As known in the art, the amount of electronic downtilt applied is adjusted to control the size of the coverage area for antenna array 120 in the elevation plane.

As shown in FIG. 1B, each output 134 of phase shifter assembly 132-1 is coupled to a respective input 142 of a respective one of beamforming networks 140-1 through 140-10. Since only three first polarization beamforming networks 140-1, 140-6, 140-10 are shown in FIG. 1B, only three of the actual connections between phase shifter assembly 132-1 and the first polarization beamforming networks 140-1 through 140-10 are explicitly shown in FIG. 1B. Labels are provided for the other outputs 134 of phase shifter assembly 132-1 to indicate how these outputs 134 connect to the other beamforming networks 140. Phase shifter assemblies 132-2 and 132-3 likewise each have ten outputs 134 that are coupled to inputs 142 of the respective first polarization beamforming networks 140-1 through 140-10. Thus, each one of the first polarization beamforming networks 140-1 through 140-10 includes a first input 142 that is connected to a respective output 134 of phase shifter assembly 132-1, a second input 142 that is connected to a respective output 134 of phase shifter assembly 132-2, and a third input 142 that is connected to a respective output 134 of phase shifter assembly 132-3. Phase shifter assemblies 132-4 through 132-6 likewise each have ten outputs 134 that are coupled to the inputs 142 of the second polarization beamforming networks 140-11 through 140-20 in the same fashion. The lines connecting the outputs 134 of phase shifter assemblies 132-2, 132-3, 132-5 and 132-6 to beamforming networks 140-1 through 140-20 are omitted in FIG. 1B, but labels are provided to indicate how these elements are interconnected.

Each beamforming network 140 has six outputs 144. Each output 144 is connected to a feedboard printed circuit board 128 that includes two radiating elements 124 of antenna array 120. The feedboard printed circuit boards 128 couple the outputs 144 of beamforming networks 140-1 through 140-10 to the first polarization radiators 126-1 of the radiating elements 124 in antenna array 120, and the feedboard printed circuit boards 128 also couple the outputs 144 of beamforming networks 140-11 through 140-20 to the second polarization radiators 126-2 of the radiating elements 124 in antenna array 120.

FIG. 1C is a schematic block diagram illustrating an example implementation of one of the beamforming networks 140 of FIG. 1B. In the implementation shown in FIG. 1C, the beamforming network 140 is implemented as a 3×6 Blass Matrix 140. The Blass Matrix 140 includes first through third inputs 142-1 through 142-3 that connect to the first respective outputs of the first through third phase shifter assemblies 132-1 through 132-3 in the manner described above with reference to FIG. 1B. The Blass Matrix 140 includes first through sixth outputs 144-1 through 144-6 that connect to six feedboards 128. The six feedboards 128 (with radiating elements 124 thereon) are shown in FIG. 1C for context. As shown in FIG. 1C, each feedboard 128 with radiating elements 124 thereon is part of a different column 122 of radiating elements 124, and the illustrated feedboards 128 form two of the rows of radiating elements 124 in antenna array 120.

Still referring to FIG. 1C, the Blass Matrix 140 includes three rows and six columns of directional couplers 150 that feed, for example, the first polarization radiators 126-1 of two of the rows of radiating elements 124 in the six-column antenna array 120. It will be appreciated that since dual-polarized radiating elements 124 are used in the multi-column array 120, a second beamforming network 140 will be provided that connects the fourth through sixth RF ports 110-4 through 110-6 to the second polarization radiators 126-2 of the radiating elements 124 shown in FIG. 1C.

The eighteen directional couplers 150 that are included in Blass Matrix 140 are arranged in three rows and six columns. The directional couplers are interconnected with each other via a plurality of transmission lines, which are shown as lines in FIG. 1C. While the directional couplers 150 are neatly arranged in rows and columns in the schematic diagram of FIG. 1C, it will be appreciated that in some actual implementations the directional couplers may be in staggered rows and/or columns or may even be more randomly located in their physical layout. However, as shown in FIG. 1C, the directional couplers 150 are functionally arranged in rows and columns given the manner in which the directional couplers 150 are interconnected and connected to the phase shifter assemblies 132 and the feedboards 128.

Delay elements 160 are provided along the transmission lines that interconnect adjacent directional couplers 150 in each row and along the transmission lines that connect the rightmost directional couplers 150 to termination resistors 170 (which are described below), such that a total of eighteen delay elements 160 are provided. The delay elements 160 and the transmission lines may be implemented together by forming the transmission lines that require larger delays as meandered transmission line segments that add a desired amount of phase delay. Each directional coupler 150 has an input port 152 (the top left port), a through port 154 (the bottom left port), an isolation port 156 (the top right port) and a coupling port 158 (the bottom right port).

One output 134 from each of the phase shifter assemblies 132-1 through 132-3 is connected to a respective one of the input ports 142-1 through 142-3 of Blass Matrix 140. The first input port 142-1 is coupled to the input port 152 of the first (leftmost) directional coupler 150 in the top row, the second input port 142-2 is coupled to the input port 152 of the first (leftmost) directional coupler 150 in the middle row, and the third input port 142-3 is coupled to the input port 152 of the first (leftmost) directional coupler 150 in the bottom row. The coupling port 158 of each of the six directional couplers 150 in the top row is coupled to a respective one of the six feedboards 128. The isolation port 156 of each of the six directional couplers 150 in the bottom row is coupled to a respective one of six loads 170 (e.g., a respective 50 Ohm resistor). The through port 154 of each directional coupler 150 in the last (rightmost) column is also coupled to a respective load 160 (e.g., a respective 50 Ohm resistor) through a respective one of the delay lines 160. The remaining ports of the directional couplers 150 are interconnected as shown. In particular, the through port 154 of each of the remaining directional couplers 150 is coupled, through a respective one of the delay lines 160, to the input port 152 of the next directional coupler 150 in the same row. Likewise, the isolation port 156 of each directional coupler 150 in a row is coupled to the coupling port 158 of the directional coupler 150 in the row below (except for the isolation ports 156 of the directional couplers 150 in the last row, as discussed above).

The multibeam sector-splitting base station antenna 100 can generate M (here M equals 3) antenna beams (per polarization) that point in different directions.

While embodiments of the present invention are discussed above as being implemented using Blass Matrix beamforming networks, it will be appreciated that embodiments of the present invention are not limited thereto. For example, in other embodiments, each Blass Matrix may be replaced with a Nolen Matrix. Example implementations of suitable Nolen Matrix designs are disclosed in PCT Patent Publication No. WO 2024/118325, published Jun. 6, 2024, the entire content of which is incorporated herein by reference. Various modified versions of a Blass Matrix and of a Nolen Matrix are also known in the art, and any of these variations may also be used in implementing the base station antennas according to embodiments of the present invention, as may other known types of beamforming networks.

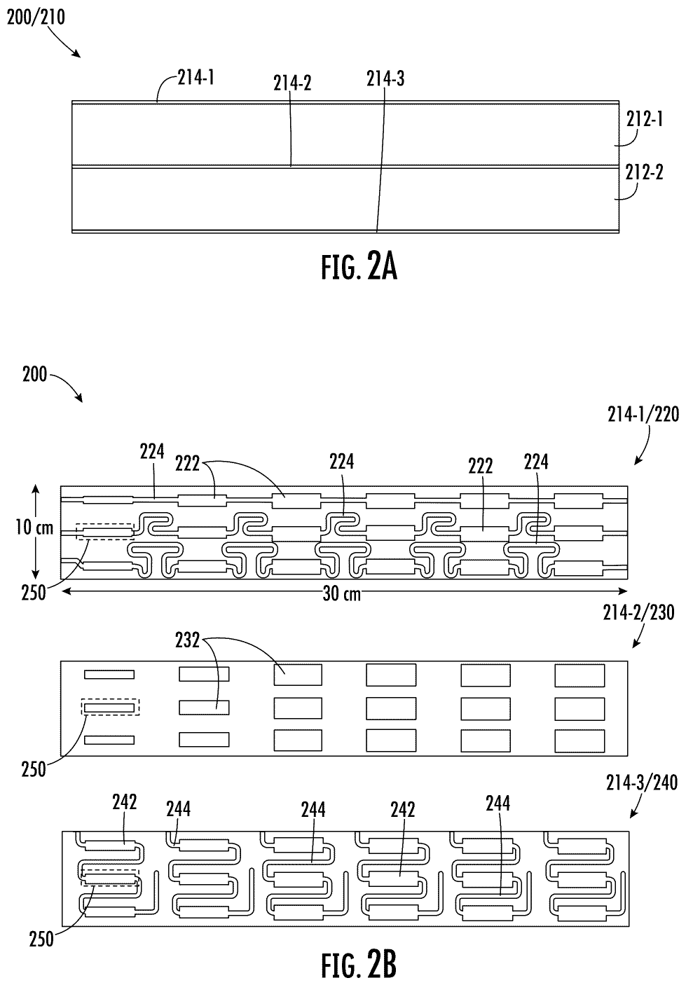

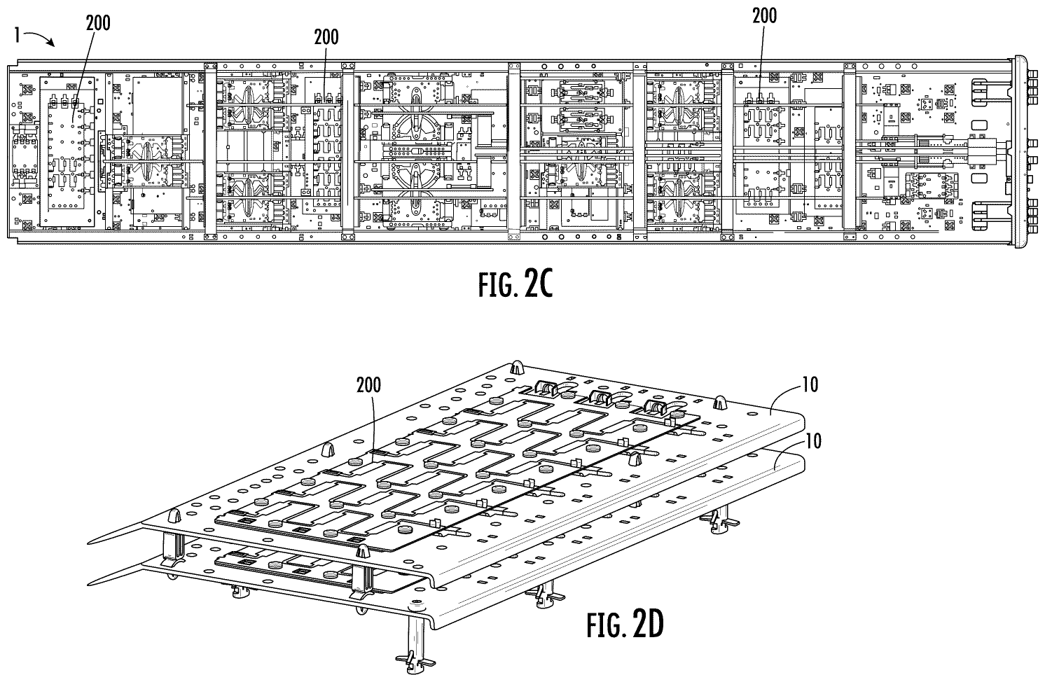

FIG. 2A is a side view of a printed circuit board implementation of a conventional 3×6 Blass Matrix beamforming network 200 that is implemented in a multi-layer printed circuit board 210. Herein, the Blass Matrix beamforming network 200 may also be referred to as a Blass Matrix printed circuit board 200. The multi-layer printed circuit board 210 includes first and second dielectric substrates 212-1, 212-2 and first through third metallization layers 214-1 through 214-3 that are sequentially stacked so that the dielectric layers 212 and the metallization layers 214 are stacked in alternating fashion. In particular, the first (upper) metallization layer 214-1 is disposed on an upper surface of the first dielectric substrate 212-1, the third (lower) metallization layer 214-3 is disposed on a lower surface of the second dielectric substrate 212-2, and the second (middle) metallization layer 214-2 is interposed in between the first and second dielectric substrates 212-1, 212-2.

FIG. 2B is a collage that includes a plan (top) view of each metallization layer of the printed circuit board of FIG. 2A. As shown in FIG. 2B, the first (upper) metallization layer 214-1 comprises a first metal pattern 220 that includes a plurality of first metal pads 222 and a plurality of first metal traces 224. The third (lower) metallization layer 214-3 comprises a third metal pattern 240 that includes a plurality of second metal pads 242 and a plurality of second metal traces 244. The second (middle) metallization layer 214-2 comprises a second metal pattern 230 that has a plurality of openings 232 therein where the metal is omitted.

Each first metal pad 222 is configured to capacitively couple with a respective one of the second metal pads 242 through a respective one of the openings 232 to form a plurality of “slot” directional couplers 250 that correspond to the directional couplers 150 that are shown in FIG. 1C. Three dotted boxes on the left side of FIG. 2B illustrate the components that form one of the directional couplers 250. The amount of coupling between the first and second metal pads 222, 242 of each directional coupler 250 may be controlled by adjusting the sizes of the first and second metal pads 222, 242 and/or the sizes of the openings 232. The locations where the first metal traces 224 connect to the left side of each first metal pad 222 correspond to the input ports 152 of the directional couplers 150 that are shown in FIG. 1C. The locations where the first metal traces 224 connect to the right side of each first metal pad 222 correspond to the through ports 154 of the directional couplers 150 that are shown in FIG. 1C. The locations where the second metal traces 244 connect to the left side of each second metal pad 242 correspond to the isolation ports 156 of the directional couplers 150 that are shown in FIG. 1C. The locations where the second metal traces 244 connect to the right side of each second metal pad 242 correspond to the coupling ports 158 of the directional couplers 150 that are shown in FIG. 1C.

The first metal traces 224 implement the delay elements 160 that are shown in FIG. 1C. As can be seen, the amount of delay provided by each delay element 160 may be constant within a row of directional couplers 150 and may incrementally increase from row-to-adjacent-row so that the smallest delay elements 160 that provide the smallest delays are in the top row of directional couplers 150 and the largest delay elements 160 that implement the largest delays are in the bottom row of directional couplers 150.

As shown in FIG. 2B, each first metal trace 224 connects the through port 154 of a first directional coupler 250 to the input port 152 of a second directional coupler 250 that is in the same row as the first directional coupler 250 and to the right of the first directional coupler 250, except that for the last directional coupler 250 in each row the first metal trace 224 that implements the delay element 160 connects the through port 154 of the directional coupler 250 to a respective termination resistor 170 (the termination resistors are not shown in FIG. 2A as they are typically implemented as surface mount resistors on the printed circuit board, but are shown in the circuit diagram of FIG. 1C). In a Blass Matrix, the amount of delay provided by each delay element 160 varies based on the position of the delay element 160 within the Blass Matrix. As shown in FIG. 2A, the delay elements 160 in “lower” rows are designed to provide longer delays. To increase the amount of delay, the first metal traces 224 in the “lower” rows of the Blass Matrix are implemented as meandered metal traces. The separation in the width direction between adjacent rows directional couplers 250 is set to allow the first metal traces 224 to have a sufficient amount of meander to achieve the desired amount of delay.

The three first metal traces 222 on the left side of FIG. 2A connect to outputs 134 of the respective first through third phase shifter assemblies 132-1 through 132-3 of FIG. 1B. The three first metal traces 222 on the right side of FIG. 2A connect to the respective termination resistors 170 on the right side of FIG. 1B. The six open-ended second metal traces 244 that terminate in the middle of the third metallization layer 214-3 connect (e.g., via coaxial cables) to respective ones of the six feedboards 228 shown in FIG. 1C. The six open-ended second metal traces 244 that terminate along the upper edge of the third metallization layer 214-3 connect to respective ones of the six termination resistors 170 (the resistors 170 are not shown in FIG. 2A, but are shown in the circuit diagram of FIG. 1C).

FIG. 2C is a rear view of a conventional multibeam sector-splitting base station antenna 1 that includes twenty of the Blass Matrix based printed circuit boards 200 of FIGS. 2A-2B. As shown in FIG. 2C, the Blass Matrix based printed circuit boards 200 are mounted in spaced-apart locations along the length of the antenna 1, with ten Blass Matrix based printed circuit boards 200 visible in FIG. 2B. Referring again to FIG. 2B, it can be seen that each major surface of the Blass Matrix printed circuit board 200 has a length of 30 cm and a width of 10 cm, for a surface area of 300 cm². Due to this large surface area, it is not possible to fit all twenty Blass Matrix printed circuit boards 200 along the length of the antenna 1. Thus, as shown in FIG. 2D, the Blass Matrix printed circuit boards 200 are stacked in pairs within the base station antenna 1 in order to fit all twenty Blass Matrix based beamforming network 200 within the antenna 1. In particular, each Blass Matrix printed circuit board 200 is mounted on a separate metal plate 10 that facilitates dissipating heat that is generated in the termination resistors 170 during operation of the antenna 1.

As discussed above, pursuant to some embodiments of the present invention, Blass Matrix beamforming networks are provided that may be significantly smaller than the Blass Matrix 200 shown in FIG. 2A. The conventional Blass Matrix 200 maintains the directional couplers 250 in rows and columns. The first metal traces 224 are meandered in the regions on the printed circuit board 210 between adjacent rows of directional couplers 250 to achieve the desired delays. This design results in a printed circuit board 210 that has a relatively large width.

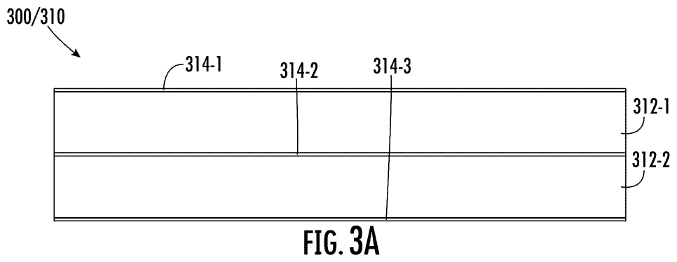

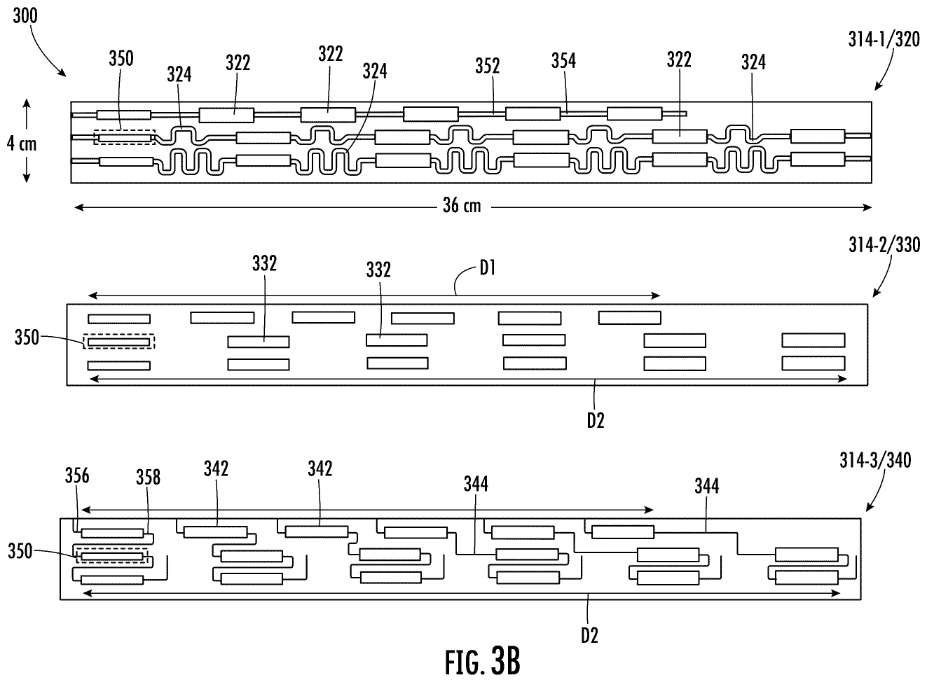

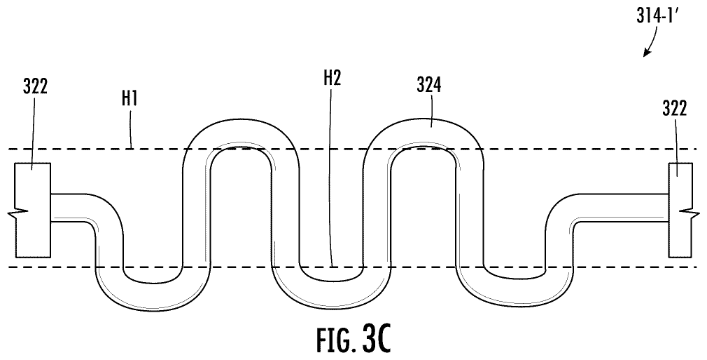

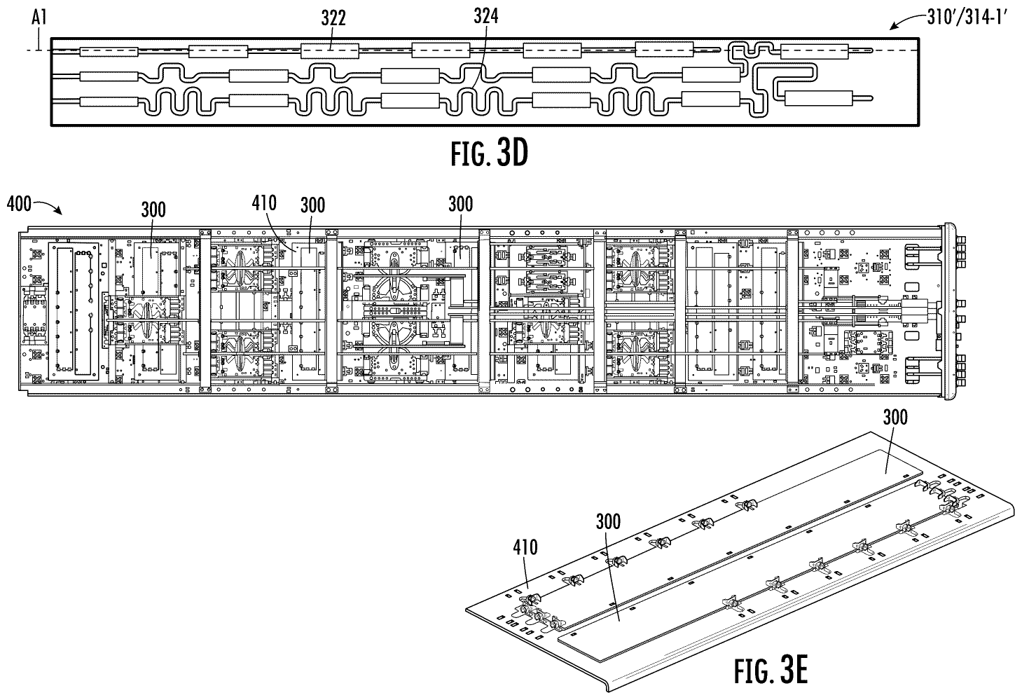

FIG. 3A is a side view of a Blass Matrix beamforming network 300 according to embodiments of the present invention that may be used to implement the Blass Matrix 140 of FIG. 1C. The Blass Matrix beamforming network 300 is implemented using a multilayer printed circuit board 310, and hence may also be referred to as a Blass Matrix printed circuit board 300 herein. FIG. 3B is a collage that provides a top view of each metallization layer of the Blass Matrix printed circuit board 310 of FIG. 3A.

As shown in FIG. 3A, the multi-layer printed circuit board 310 includes first and second dielectric substrates 312-1, 312-2 and first through third metallization layers 314-1 through 314-3 that are sequentially stacked so that the dielectric layers 312 and the metallization layers 314 are stacked in alternating fashion, with the first (upper) metallization layer 314-1 on an upper surface of the first dielectric substrate 312-1, the third (lower) metallization layer 314-3 on a lower surface of the second dielectric substrate 312-2, and the second (middle) metallization layer 314-2 in between the first and second dielectric substrates 312-1, 312-2.

Referring to FIG. 3B, the first (upper) metallization layer 314-1 comprises a metal pattern 320 that includes a plurality of first metal pads 322 and a plurality of first metal traces 324. The third (lower) metallization layer 314-3 comprises a metal pattern 340 that includes a plurality of second metal pads 342 and a plurality of second metal traces 344. The second (middle) metallization layer 314-2 comprises a metal pattern 330 that has a plurality of openings 332 therein where the metal is omitted. Each first metal pad 322 is configured to capacitively couple with a respective one of the second metal pads 342 through a respective one of the openings 332 to form a plurality of directional couplers 350 that correspond to the directional couplers 150 in FIG. 1C. The three dotted boxes in FIG. 3B illustrate the components that form one of the directional couplers 350. The locations where the first metal traces 324 connect to the left side of each first metal pad 322 form the input ports 352 of the directional couplers 350, while the locations where the first metal traces 324 connect to the right side of each first metal pad 322 form the through ports 354 of the directional couplers 350. The locations where the second metal traces 344 connect to the left side of each second metal pad 342 form the isolation ports 356 of the directional couplers 350, and the locations where the second metal traces 344 connect to the right side of each second metal pad 342 form the coupling ports 358 of the directional couplers 350. The first metal traces 324 interconnect the first metal pads 322 in the same fashion as shown in FIG. 2B, and the second metal traces 344 interconnect the second metal pads 342 in the same fashion as shown in FIG. 2B. The first metal traces 324 implement the delay elements 160 that are shown in FIG. 1C. Thus, the Blass Matrix printed circuit board 300 has the same general design as the Blass Matrix printed circuit board 200 of FIGS. 2A-2B.

Each directional coupler 350 is a slot directional coupler as the slots 332 in the second metallization layer 314-2 are interposed between the first metal pads 322 and the second metal pads 342 so that RF energy may couple between each first metal pad 322 and a respective one of the second metal pads 342 through a respective one of the slots 332. The amount of coupling between the first metal pad 322 and the second metal pad 342 is a function of the length of the slot 332, the width of the slot 332, the thicknesses and dielectric constants of the first and second dielectric substrates 312-1, 312-2, and the widths of the first and second metal pad 322, 342. In the depicted embodiment, each slot 332 has the same length (i.e., the same length in the length dimension) and the thicknesses and dielectric constants of the first and second dielectric substrates 312-1, 312-2 are constant so the amount of coupling between the first metal pad 322 and the second metal pad 342 may be set by appropriately adjusting the width of the slot 332 and the widths of first and second metal pad 322, 342. In the depicted embodiment the first and second metal pad 322, 342 have the same width for each directional coupler 350, but the widths differ for different directional couplers 350. The widths of the first and second metal pad 322, 342 and the slots 332 may be selected to achieve a desired amount of coupling while also maintaining a desired impedance to minimize return loss.

The first metal traces 324 of printed circuit board 310, however, have a different design than the first metal traces 224 of printed circuit board 210. In addition, the layout of the first and second metal pads 322, 342 is modified in printed circuit board 310 as compared to printed circuit board 210. In particular, as shown in FIG. 3B, in Blass Matrix printed circuit board 300, the distances between the first metal pads 322 and the distances between the second metal pads 324 in the lower two rows of directional couplers 350 is increased as compared to the corresponding distances between the first metal pads 222 and the distances between the second metal pads 224 in the lower two rows of directional couplers 250 in Blass Matrix printed circuit board 200. As a result, the length of the printed circuit board 310 is increased to 36 cm from 30 cm for printed circuit board 210. Moreover, since the first metal traces 324 in the first row do not have any meander to obtain a desired amount of delay, the first metal pads 322 in the upper row are offset from the corresponding first metal pads 322 in the lowermost of the two rows. Since the distances between the first metal pads 322 in the lower two rows of directional couplers 350 is increased, it is possible to form the first metal traces 324 in the bottom row to have a wave shape having multiple peaks and valleys. This allows the first metal traces 324 in the bottom row to achieve a desired amount of delay while keeping the vast majority of each first metal trace 324 in the bottom row in between a first horizontal axis H1 defined by the first metal pad 322 in the bottom row that has an upper edge that is closest to the upper edge (in the view of FIG. 3B) of the printed circuit board 310 and a second horizontal axis H2 defined by the first metal pad 322 in the bottom row that has a lower edge that is closest to the lower edge (in the view of FIG. 3B) of the printed circuit board 310. This can best be seen with reference to FIG. 3C.

Referring first to FIG. 3C, it can be seen that the rightmost first metal pad 322 has an upper edge that is closest to the upper edge of the printed circuit board 310 and a lower edge that is closest to the lower edge of the printed circuit board 310. Thus, the upper and lower edges of the rightmost first metal pad 322 define the first and second horizontal axes H1, H2, respectively. As shown in FIG. 3C, over 65% of the area of each first metal trace 324 is interposed in the region defined between a respective pair of adjacent first metal pads 322 (i.e., in the region defined by the edges of the two first metal pads 322 and the first and second horizontal axes H1, H2). In sharp contrast, in the design of FIG. 2A less than 25% of the area of each first metal trace 224 in the bottom row is interposed in the region defined between the two adjacent first metal pads 222. In example embodiments, at least 35%, at least 40%, at least 45%, at least 50%, at least 55%, at least 60% or at least 70% of the area of each first metal trace 324 is interposed in the region defined between the two first metal pads 322 that are connected by the first metal trace 324. As a result of this design, the distances between adjacent rows of first metal pads 322 may be reduced significantly, allowing the width of printed circuit board 310 to be reduced to 4 cm as compared to a width of 10 cm for printed circuit board 210. The surface area of printed circuit board 310 is thus less than half the surface area of printed circuit board 210.

FIG. 3D is a plan view of the first metallization layer 314-1′of a modified version 310′of printed circuit board 310. As can be seen by comparing FIGS. 3B and 3D, the two first metallization layer 314-1, 314-1′may be identical except that the rightmost first metal pad 322 in the middle row of directional couplers 350 in first metallization layer 314-1 is moved in first metallization layer 314-1′to the open space to the right of the first row of directional couplers 350, which allows the meandered portions of the first metal traces 324 that connect the two rightmost first metal pads 322 in the lower two rows of directional couplers 350 to extend into other rows of directional couplers 350. In other words, in first metallization layer 314-1′the rightmost first metal pad 322 in the middle row is moved into the empty space in the upper right corner of first metallization layer 314-1, which provides additional room to implement the next to rightmost first metal traces 324 in the lower two rows of directional couplers 350. This extra room allows the rightmost first metal pads 322 in the lower two rows of directional couplers 350 to be shifted to the left, allowing the length of first metallization layer 314-1′to be reduced by perhaps 5-8%. In printed circuit board 310′the slots 332 in the second metallization layer 314-2′and the second metal pads 342 in the third metallization layer 314-3′that correspond to the rightmost metal pads 322 in the lower two rows of directional couplers are shifted so that they are aligned with the first metal pads 322. The net result is that the length of the printed circuit board 310′may be on the order of 5-8% less than the length of printed circuit board 310. This can reduce the length of printed circuit board 310 to 33-34 cm or even less.

As shown in FIG. 3D, a first axis A1 intersects all of the directional couplers 350 in the upper row of directional couplers 350. In addition, the first axis A1 also intersects the rightmost directional coupler 350 in the middle row since that directional coupler 350 has been moved upward into the empty space at the end of the first row of directional couplers 350 in this embodiment.

FIG. 3E is a rear view of a multibeam sector-splitting base station antenna 400 that is implemented using twenty of the Blass Matrix printed circuit boards 300 of FIGS. 3A-3B. As can be seen, due to their reduced size, two Blass Matrix printed circuit boards 300 can be mounted on each metal plate 410. Thus, base station antenna 400 requires ten fewer metal plates 410 as compared to base station antenna 1, reducing the material cost, weight and fabrication difficulty of base station antenna 400 as compared to base station antenna 1. In addition, the smaller Blass Matrix printed circuit boards 310 further reduce the material costs of base station antenna 400 as compared to base station antenna 1.

Referring again to FIGS. 3A-3D in conjunction with FIGS. 1A-1C, it can be seen that pursuant to some embodiments of the present invention, a multibeam sector-splitting base station antenna 100 is provided that comprises an antenna array 120 that includes a plurality of columns 122 of radiating elements 124 and a beamforming network 300 having at least two rows and two columns of directional couplers 350, where adjacent pairs of directional couplers 350 in each row are connected to each other by respective ones of a plurality of delay lines 324, 344, where at least some of the delay lines 324 have a wave shape having multiple peaks and valleys. In some embodiments, at least one of the delay lines 324 may have a wave shape with at least three peaks or three valleys.

In some embodiments, the antenna array includes N columns 122 of radiating elements 124 and a plurality of RF ports 110 are coupled to the antenna array 120 through the beamforming network 300. The beamforming network 300 may have M rows and N columns of directional couplers 350. In some embodiments, each row of the beamforming network 300 may have a different number of directional couplers 350 (e.g., Blass Matrix embodiments). In other embodiments, each row of the beamforming network 300 may have a same number of directional couplers 350 (e.g., Nolen Matrix embodiments).

The multibeam antenna 100 may also include a reflector 102, and radiators 126 of the radiating elements 124 of the antenna array 120 may be mounted forwardly of the reflector 102, and the beamforming network 300 may also be mounted forwardly of the reflector 102. In some embodiments, the beamforming network 300 may be implemented in a printed circuit board 310, and the printed circuit board 310 may be mounted on a front surface of the reflector 102. In some embodiments, at least some of the radiating elements 124 that are fed by the beamforming network 300 may be mounted on the printed circuit board 310.

As can be seen in FIG. 3B, a first distance D1 between a first and a last of the directional couplers 350 in a first of the rows (here the upper row) may be less than a second distance D2 between a first and a next to last of the directional couplers 350 in a second of the rows (here, either the middle row or the bottom row).

As shown in FIG. 3D, in some embodiments, a first axis A1 intersects all of the directional couplers 350 in a first of the rows as well as at least one of the directional couplers 350 that is part of a second of the rows.

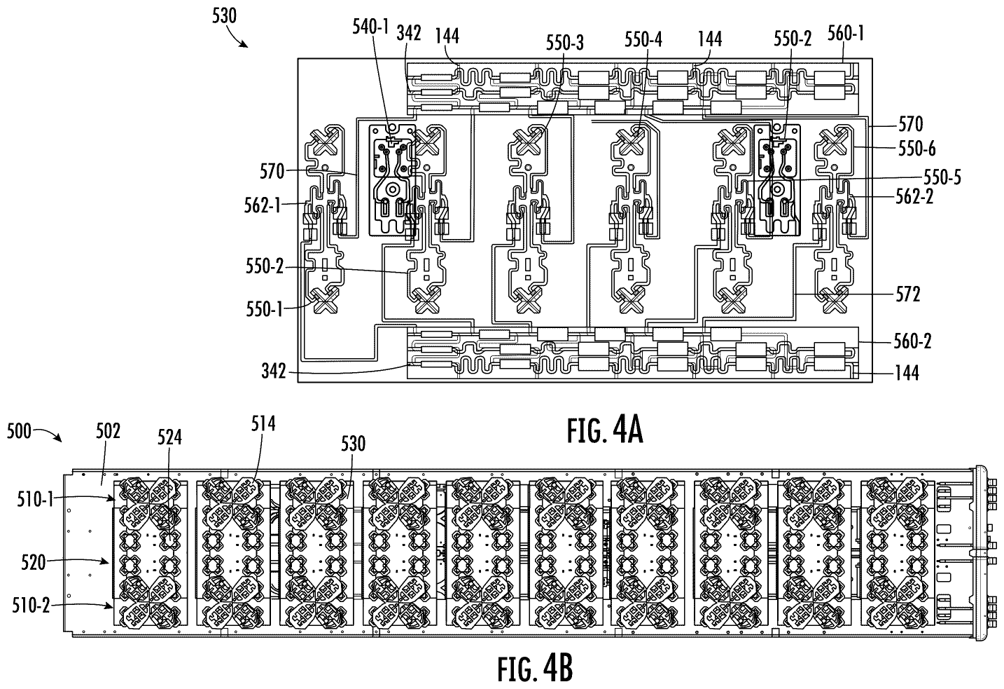

The smaller size of the Blass Matrix printed circuit boards 300 may also open the possibility of other design changes that can further reduce the cost of a multibeam sector-splitting base station antenna and/or improve the performance thereof. For example, FIGS. 4A-4B illustrate a multibeam sector-splitting base station antenna 500 according to further embodiments of the present invention that incorporates pairs of the miniaturized Blass Matrix printed circuit boards 300 of FIGS. 3A-3B onto large feedboard printed circuit boards so that each Blass Matrix is implemented in the same printed circuit board as the six feedboard printed circuit boards that it feeds.

In particular, FIG. 4A is a plan view of a multipurpose printed circuit board 530 that includes a first and second Blass Matrices and the eight feedboards implemented therein.

As shown in FIG. 4A, the printed circuit board 530 includes two low-band feedboard regions 540-1, 540-2, six mid-band feedboard regions 550-1, 550-2, and a pair of Blass Matrix regions 560-1, 560-2. Blass Matrix region 560-1 implements a first Blass Matrix 300-1 and Blass Matrix region 560-1 implements a second Blass Matrix 300-2. The printed circuit board 530 may comprise a pair of dielectric substrates as well as three metallization layers that are arranged in the same manner that the corresponding layers of Blass Matrix printed circuit board 310 of FIGS. 3A-3B. Each Blass Matrix region 560 may implement a Blass Matrix that is identical to the Blass Matrix 300 of FIGS. 3A-3B. Each low-band feedboard region 540 may comprise a mounting location for a low-band radiating element 514 (see FIG. 4B) of the multibeam sector-splitting base station antenna 500. A pair of feed cables (not shown) for the low-band radiating element 514 may terminate into each low-band feedboard region 540. Each mid-band feedboard region 550 may similarly comprise a mounting location for a mid-band radiating element 524 (see FIG. 4B) of the multibeam sector-splitting base station antenna 500.

FIG. 4B is a schematic front view of a multibeam sector-splitting base station antenna 500 (with the radome removed. As shown in FIG. 4B, the multibeam sector-splitting base station antenna 500 includes a reflector 502. First and second linear arrays 510-1, 510-2 of low-band radiating elements 514 are mounted to extend forwardly from the reflector 502. A multi-column array 520 of mid-band radiating elements 524 is also provided, with the mid-band radiating elements 524 also extending forwardly from the reflector 502. The reflector 502 may comprise a flat metal surface that acts as a ground plane for the radiating elements 514, 524 and that redirects forwardly RF radiation that is emitted rearwardly by the radiating elements 514, 524. Base station antenna 500 further includes ten of the multipurpose printed circuit boards 530 of FIG. 4A. Each multipurpose printed circuit board 530 is mounted on the front side of the reflector 502. This is in contrast to the base station antenna 1 of FIG. 2B, where the Blass Matrix printed circuit boards 200 are mounted rearwardly of the reflector 2.

As shown in FIG. 4B, ten multipurpose printed circuit boards 530 can fit on the front side of the reflector 502 because each Blass Matrix region 560 has a significantly reduced width (4 cm as compared to 10 cm for the conventional Blass Matrix printed circuit board 200 of FIGS. 2A-2B). Notably, mounting the multipurpose printed circuit boards 530 on the reflector 502 is advantageous because the reflector 502 is a large sheet of metal that may be very effective at dissipating the heat that is generated in the resistors that are surface mounted in each Blass Matrix region 560 (these resistors correspond to the resistors 170 in FIG. 1C). In addition, since the multipurpose printed circuit boards 530 are mounted directly on the reflector 502 (although a thin dielectric layer such as a solder mask may be interposed between each multipurpose printed circuit board 530 and the reflector 502), the need for the twenty metal plates 10 of antenna 1 or the ten metal plates 410 of antenna 400 may be eliminated. This reduces cost, antenna weight and assembly time.

The feed networks for the array 520 of mid-band radiating elements 524 included in base station antenna 500 may have the design shown in FIG. 1B. Moreover, each Blass Matrix region 560 formed in the multipurpose printed circuit boards 530 may have the design shown in FIG. 1C, and may be implemented in the manner shown in FIGS. 3A-3B (or FIG. 3D). Referring again to FIG. 4A, the first Blass Matrix region 560-1 includes three inputs 342. Each of these inputs 142 may be connected (e.g., via coaxial cables, not shown) to an output of a respective first polarization phase shifter assembly 132-1 through 132-3 in the manner shown in FIG. 1B. The six outputs 144 of the first Blass Matrix region 560-1 are connected to the respective six mid-band feedboard regions 550-1 through 550-6 by respective first microstrip transmission lines 570. Similarly, the three inputs to the second Blass Matrix region 560-2 are connected (e.g., via coaxial cables, not shown) to an output of a respective second polarization phase shifter assembly 132-4 through 132-6 in the manner shown in FIG. 1B. The six outputs 144 of the second Blass Matrix region 560-2 are also connected to the respective six mid-band feedboard regions 550-1 through 550-6 by respective second microstrip transmission lines 572. Each mid-band feedboard region 560 includes a first power divider 562-1 that is connected to a respective one of the first microstrip transmission lines 570. The first power divider 562-1 has two outputs that are connected to the feed lines for first polarization radiators 526-1 of the two mid-band radiating elements 524 that are mounted in each mid-band feedboard region 560. Each mid-band feedboard region 560 further includes a second power divider 562-2 that is connected to a respective one of the second microstrip transmission lines 572. The second power divider 562-2 has two outputs that are connected to the feed lines for second polarization radiators 526-2 of the two mid-band radiating elements 524 that are mounted in each mid-band feedboard region 560.

Conventionally, coaxial cables are used to connect each output of a Blass Matrix printed circuit board to a feedboard printed circuit board that includes one or more radiating elements that are fed by the Blass Matrix printed circuit board. Such a design requires that the antenna include a large number of coaxial cables, each of which must be soldered to both a Blass Matrix printed circuit board and to a feedboard printed circuit board. A base station antenna that includes ten Blass Matrix printed circuit boards that each have six outputs would therefore require sixty coaxial cables to interconnect the ten Blass Matrix printed circuit boards to their associated feedboard printed circuit boards, which would require 240 solder joints (namely a solder joint for the center conductor and a solder joint for the ground connector at each end of each coaxial cable). Forming these 240 solder joints is a labor intensive operation that increases cost and fabrication time. In addition, solder joints are a potential source of PIM distortion. If such PIM distortion is discovered during factory testing, the faulty solder joints must be identified and redone.

Since base station antenna 500 employs multipurpose printed circuit boards 530 that implement both the Blass Matrices and the feedboards in a single printed circuit board, the first and second microstrip transmission lines 570, 572 replace the above-described coaxial cables, reducing cost and fabrication time and avoiding the above-described potential PIM distortion problems.

Still referring to FIGS. 4A-4B, it can be seen that pursuant to further embodiments of the present invention, multibeam sector-splitting base station antennas 500 are provided that comprise an antenna array 520 that includes a plurality of columns of radiating elements 524 and a multipurpose printed circuit board 530 that includes a plurality of feedboard regions 550, a first beamforming region 560-1 that includes a first beamforming network 300 that comprises a plurality of directional couplers 350 and a plurality of outputs, and a plurality of transmission lines 570 that connect at least some of the outputs of the beamforming network 300 to respective ones of the feedboard regions 550, where each feedboard region 550 has one or more of the radiating elements 524 of the antenna array 520 mounted thereon.

In some embodiments, the multipurpose printed circuit board 530 may further include a second beamforming region 560-2 that comprises a second beamforming network 300, and at least some of the feedboard regions 540, 550 are interposed between the first beamforming region 560-1 and the second beamforming region 560-2. In some embodiments, the transmission lines 570, 572 may be microstrip transmission lines.

As described above, the beamforming network(s) 300 may comprise a Blass Matrix. At least one of the outputs of the beamforming network 300 is connected to a feedboard printed circuit board 528-1 by a coaxial cable, where the feedboard printed circuit board 528-1 is part of an outer one of the columns of radiating elements in the antenna array 520.

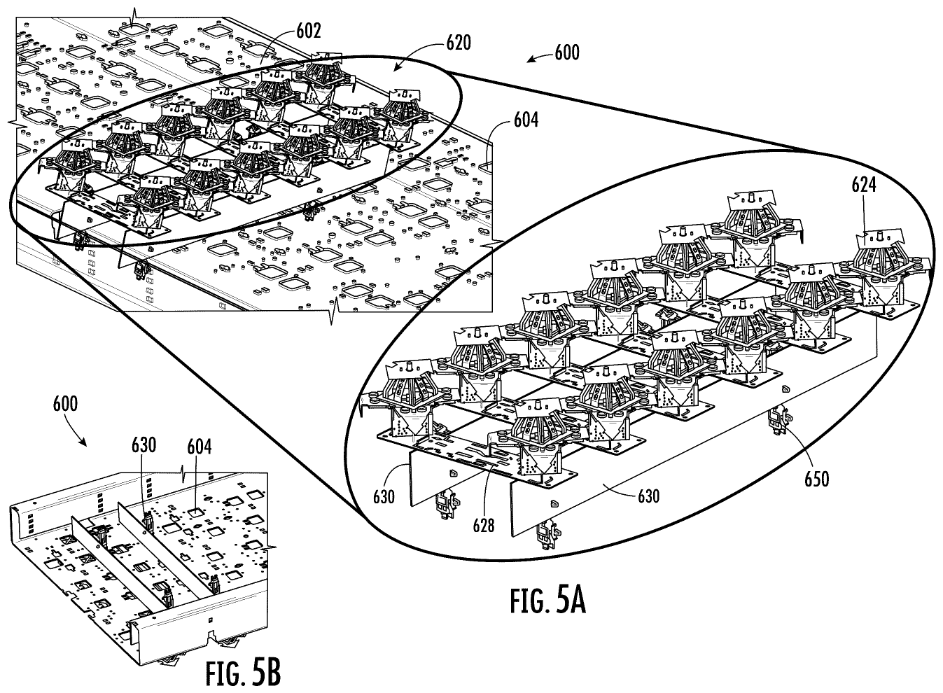

FIGS. 5A and 5B illustrate a multibeam sector-splitting base station antenna 600 according to further embodiments of the present invention. In particular, FIG. 5A is a schematic partial view of the multibeam sector-splitting base station antenna 600, and FIG. 5B is a perspective review view of a small portion of the antenna 600 that illustrates how the Blass Matrix printed circuit boards 630 can be mounted behind a reflector 602 of antenna 600. In FIGS. 5A-5B, only the reflector 602, two Blass Matrix printed circuit boards 630, six mid-band radiating element feedboards 628, twelve mid-band radiating elements 624 and a plurality of plastic supports 650 that hold the Blass Matrix printed circuit boards 630 in place are shown, with all other elements of antenna 600 omitted to simplify the drawings.

As shown in FIGS. 5A-5B, each mid-band feedboard printed circuit board 628 is mounted in front of the reflector 602. A pair of mid-band radiating elements 624 are mounted to extend forwardly from each mid-band feedboard printed circuit board 628. Each mid-band feedboard printed circuit board 628 may be identical to the mid-band feedboard regions 550 of multipurpose printed circuit board 530, except that the mid-band feedboard printed circuit boards 628 are implemented as separate printed circuit boards as opposed to being part of a larger printed circuit board. Thus, further description of the mid-band feedboard printed circuit boards 628 will be omitted here. As shown in FIGS. 5A-5B, a plurality of Blass Matrix printed circuit boards 630 are mounted behind the reflector 602 of antenna 600. Each Blass Matrix printed circuit board 630 may be implemented using one of the Blass Matrix printed circuit boards 310 of FIGS. 3A-3B.

Each Blass Matrix printed circuit board 630 is mounted generally perpendicular to the plane defined by the main surface of the reflector 602, with the length dimension of the Blass Matrix printed circuit board 630 extending in the transverse direction of the antenna 600 and the width dimension of the Blass Matrix printed circuit board 630 extending in the longitudinal direction of the antenna 600. The Blass Matrix printed circuit boards 630 may be oriented in this manner since the width of each Blass Matrix printed circuit board 630 has been reduced significantly as compared to conventional Blass Matrix printed circuit boards, and thus the Blass Matrix printed circuit board 630 will not extend to far in the depth direction of antenna 600. The plastic supports 650 may have snap clips or other features that are used to mount the supports 650 within openings 604 in the reflector 602. The plastic supports 650 may hold each Blass Matrix printed circuit board 630 in its proper position perpendicular to the reflector 602.

The design of antenna 600 avoids the need to stack Blass Matrix printed circuit boards 630 as is done in conventional antennas, and may reduce the cost, weight and manufacturing time of antenna 600 as compared to a conventional multibeam antenna. In addition, the outputs of the Blass Matrix printed circuit board 630 may be directly connected to the mid-band feedboard printed circuit boards 628 without the need for coaxial cable connections. This may reduce the number of soldering operations in half (e.g., 120 solder joints may be eliminated) and may eliminate the weight and cost of the coaxial cables.

Still referring to FIGS. 5A-5B, the multibeam sector-splitting base station antenna 600 comprises a reflector 602, an antenna array 620 (which is only partially shown in FIGS. 5A-5B) that includes a plurality of columns of radiating elements 624, where the radiating elements 624 extend forwardly from the reflector 602, and a beamforming network printed circuit board 630 that is mounted behind the reflector 602, the beamforming network printed circuit board 630 including tabs 632 that extend through openings 604 in the reflector 602 to electrically connect to a subset of the radiating elements 624.

The multibeam antenna 600 further comprises a plurality of feedboard printed circuit boards 628 that are mounted forwardly of the reflector 602, and each tab 632 in the beamforming network printed circuit boards 632 may extend through a slot in a respective one of the feedboard printed circuit boards 628.

The beamforming network printed circuit board 630 may be mounted substantially perpendicularly to a main surface of the reflector 602. The beamforming network included on the beamforming network printed circuit board 630 may, for example, be implemented using the beamforming networks 300 of FIGS. 3A-3C or of FIG. 3D.

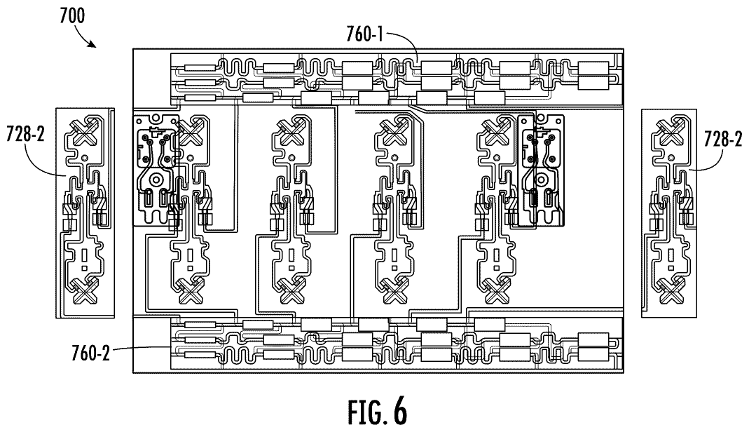

FIG. 6 is a schematic view of a multipurpose printed circuit board 700 according to further embodiments of the present invention that is a modified version of the multipurpose printed circuit board 530 of FIG. 4A. As can be seen by comparing FIGS. 4A and 6, the primary difference between multipurpose printed circuit board 700 and multipurpose printed circuit board 530 is that multipurpose printed circuit board 700 does not include the outer two mid-band feedboard regions 550-1, 550-6. One disadvantage of integrating the Blass Matrix printed circuit board 300 into a multipurpose printed circuit board 530 that includes the mid-band feedboard regions 550 as is done in the embodiment of FIG. 4A is that the insertion loss of the microstrip transmission lines 570, 572 included in multipurpose printed circuit board 530 is significantly higher than the insertion losses of the coaxial cables that they replace. When the microstrip transmission lines 570, 572 connecting the beamforming network regions 560 to the mid-band feedboard regions 550 are short, this increase in insertion loss is manageable because it will be small (e.g., less than 0.1 dB). However, as can be seen in FIG. 4A, the length of the microstrip transmission lines 570, 572 that connect the outputs of the beamforming network regions 560 to the outermost mid-band feedboard regions 550-1, 550-6 may be nearly twice as long as the microstrip transmission lines 570, 572 that connect the outputs of the beamforming network regions 560 to the inner four mid-band feedboard regions 550-2 through 550-5. Thus, the insertion loss will be higher along the microstrip transmission lines 570, 572 that feed the mid-band radiating elements 524 in the outer two columns of the mid-band array 520.

As shown in FIG. 6, in order to reduce the insertion loss, only four mid-band feedboard regions 550-2 through 550-5 are implemented on the multi-purpose printed circuit board 700, and the mid-band radiating elements 524 for the outer columns of mid-band radiating elements 524 are mounted on separate mid-band feedboard printed circuit boards 728-1, 728-2. Coaxial cables (not shown) are used to connect the outermost two outputs of each beamforming network region 760-1, 760-2 to these separate mid-band feedboard printed circuit boards 728. This may improve the insertion loss performance for the mid-band antenna array. In addition, the overall size of the multi-purpose printed circuit board 700 may be reduced as compared to the multi-purpose printed circuit board 530, and wasted space on the multi-purpose printed circuit board 530 is eliminated so that the overall cost may be reduced.

While the above examples of the present invention are primarily of three-beam sector-splitting base station antennas, it will be appreciated that embodiments of the present invention are not limited thereto. In other embodiments the base station antenna may generate two antenna beams per polarization or may generate more than three antenna beams (e.g., four, five, six, seven, eight, nine or more per polarization). Generally speaking, the number of columns of radiating elements tends to increase with an increasing number of antenna beams. For example, a multibeam base station antenna according to embodiments of the present invention that is configured to generate four antenna beams per polarization might have an eight column antenna array. The number of rows in each beamforming network may be equal to the number of antenna beams generated by the antenna per polarization. Thus, a four-beam (per polarization) multibeam antenna according to embodiments of the present invention may, for example, include Blass Matrices that have four rows and eight columns of directional couplers. The number of antenna columns included in the multibeam base station antennas according to embodiments of the present invention may be set based on desired amounts of sidelobe suppression and interference between adjacent antenna beams. The azimuth beamwidth of each antenna beam may be selected based on the spacing between adjacent columns of radiating elements and the azimuth beamwidth of the individual radiating elements.

In the discussion above, references are made to the “rows” and “columns” of the beamforming networks according to embodiments of the present invention. It will be appreciated that the “rows” and “columns” are defined functionally based on the interconnections between the directional couplers and that the directional couplers need not be physically aligned in actual rows and columns when implemented.

It will be appreciated that the present specification only describes a few example embodiments of the present invention and that the techniques described herein have applicability beyond the example embodiments described above.

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A multibeam antenna, comprising:
an antenna array that includes a plurality of columns of radiating elements; and
a beamforming network having at least two rows and two columns of directional couplers, where adjacent pairs of directional couplers in each row are connected to each other by respective ones of a plurality of delay lines, where at least some of the delay lines have a wave shape having multiple peaks and valleys.

2. The multibeam antenna of claim 1, wherein the antenna array includes N columns of radiating elements and a plurality of radio frequency (“RF”) ports are coupled to the antenna array through the beamforming network.

3. The multibeam antenna of claim 1, wherein the beamforming network has M rows and N columns of directional couplers.

4. The multibeam antenna of claim 3, wherein each row has a different number of directional couplers.

5. The multibeam antenna of claim 3, wherein each row has a same number of directional couplers.

6. The multibeam antenna of claim 1, further comprising a reflector, wherein radiators of the radiating elements of the antenna array are mounted forwardly of the reflector, and the beamforming network is also mounted forwardly of the reflector.

7. The multibeam antenna of claim 6, wherein the beamforming network is implemented in a printed circuit board, and the printed circuit board is mounted on a front surface of the reflector.

8. The multibeam antenna of claim 1, wherein the beamforming network is implemented in a printed circuit board and at least some of the radiating elements that are fed by the beamforming network are mounted on the printed circuit board.

9. The multibeam antenna of claim 1, wherein at least one of the delay lines has a wave shape with at least three peaks or three valleys.

10. The multibeam antenna of claim 1, wherein a first axis intersects all of the directional couplers in a first of the rows as well as at least one of the directional couplers that is part of a second of the rows.

11. The multibeam antenna of claim 1, wherein a first distance between a first and a last of the directional couplers in a first of the rows is less than a second distance between a first and a next to last of the directional couplers in a second of the rows.

12. The multibeam antenna of claim 1, wherein the beamforming network is implemented in a beamforming network printed circuit board that is mounted behind a reflector of the base station antenna, and the beamforming network printed circuit board includes tabs that extend through openings in the reflector to electrically connect to a subset of the radiating elements.

13. The multibeam antenna of claim 12, further comprising a plurality of feedboard printed circuit boards that are mounted forwardly of the reflector, wherein each tab in the beamforming network printed circuit board extends through a slot in a respective one of the feedboard printed circuit boards.

14. The multibeam antenna of claim 12, wherein the beamforming network printed circuit board is mounted substantially perpendicularly to a main surface of the reflector.

15-34. (canceled)

35. A multibeam antenna, comprising:
an antenna array; and
a beamforming network having a plurality of directional couplers that are interconnected by a plurality of transmission lines to define a plurality of rows and columns of directional couplers,
wherein a first axis intersects all of the directional couplers in a first of the rows as well as at least one of the directional couplers that is part of a second of the rows.

36. The multibeam antenna of claim 35, wherein there are at least three rows of directional couplers and at least four columns of directional couplers.

37. The multibeam antenna of claim 35, wherein a second axis that is perpendicular to the first axis intersects the first directional coupler in each of the rows of directional couplers.

38. The multibeam antenna of claim 35, wherein a first distance between a first and a last of the directional couplers in a first of the rows is less than a second distance between a first and a next to last of the directional couplers in a second of the rows.

39. The multibeam antenna of claim 35, wherein the beamforming network comprise a Blass Matrix or a Nolen Matrix.

40. A multibeam antenna, comprising:
an antenna array; and
a beamforming network having a plurality of directional couplers that are interconnected by a plurality of transmission lines to define a plurality of rows and columns of directional couplers,
wherein a first distance between a first and a last of the directional couplers in a first of the rows is less than a second distance between a first and a next to last of the directional couplers in a second of the rows.

41. The multibeam antenna of claim 40, wherein the transmission lines in a first of the rows are straight transmission lines and the transmission lines in a last of the rows are meandered transmission lines.
